(19) United States
(12) Patent Application Publication
(10) Pub. No.: US 2008/0016161 A1
(43) Pub. Date: Jan. 17, 2008

(54) Methods and apparatus for using electronic envelopes to configure parameters

(76) Inventors: George Tsirtsis, New York, NY (US); Vincent D. Park, Budd Lake, NY (US)

Correspondence Address: QUALCOMM INCORPORATED, 5775 MOREHOUSE DR., SAN DIEGO, CA, 92121, US

(21) Appl. No.: 11/486,749

(22) Filed: Jul. 14, 2006

(51) Int. Cl. G06F 15/16

(52) U.S. Cl. 709/206

(57) ABSTRACT

A method of configuring parameters in a communication system is disclosed, wherein the method comprising determining if an event occurred. If so, then method generating a first electronic envelope by a first process, wherein the envelope comprises an process identification (ID) and attaching the first electronic envelope to a request message, wherein the request message is generated by a transmit process.

### FIELD

This invention relates to communications system and, more particularly, to methods and apparatus for using an electronic envelope scheme to configure parameters.

### BACKGROUND

In a communication system, two entities, for example terminal and base station communicate with each other. There are several processes that operate in parallel for robustness of the wireless communication system. Each of these processes maintains set of parameter values. Generally, based on an event in the system, for example, connection establishment, QOS or handoff, certain parameters for the processes are required to be collected and/or modified. In a typical communication system, these processes are operating independently from each other. Generally, for each event one or more processes may require additional parameters or modification to parameters used within the process. Thus, each process will generate a request message and transmit request message to, for example, a base station. For each request, at least one physical resource will be required. Thus, each process will be required to consume a physical resource for each event. Depending on a type of event, there may be several processes that require consumption of physical resources. Also, upon receiving a request, the base station will either comply with request or reject the request. It will also consume a physical resource for each reply. Thus, a given event (e.g., handoff) may trigger several handshakes (transmission of request and receiving a response to the request) that may occur for the different processes that need to react to the event. In a communication system that has limited bandwidth and low latency requirement, these separate handshakes will tie up valuable resources. Therefore, it would be efficient, to use a method to establish parameters between two entities that does not require unnecessary handshakes.

### SUMMARY

In accordance with various embodiments, a method of configuring parameters in a communication system is disclosed, wherein the method comprising determining if an event occurred. If so, then method generating a first electronic envelope by a first process, wherein the envelope comprises an process identification (ID) and attaching the first electronic envelope to a request message, wherein the request message is generated by a transmit process.

In another aspect, an apparatus for configuring parameters in a communication system is described, wherein the apparatus comprises means for determining if an event occurred. The apparatus also comprises means for generating a first electronic envelope by a first process, wherein the envelope comprises an process identification (ID) and means for attaching the first electronic envelope to a request message, wherein the request message is generated by a transmit process.

In another aspect, a machine-readable medium comprising instructions which, when executed by a machine, cause the machine to perform operations including: determining if an event occurred; generating a first electronic envelope by a first process, wherein the envelope comprises an process identification (ID); and attaching the first electronic envelope to a request message, wherein the request message is generated by a transmit process.

In an aspect, a processor configured to determine if an event occurred; the processor configured to generate a first electronic envelope by a first process, wherein the envelope comprises an process identification (ID); and the processor configured to attach the first electronic envelope to a request message, wherein the request message is generated by a transmit process.

In another aspect, an apparatus for configuring parameters in a communication system, the apparatus comprising means for receiving a request message, wherein the request message comprises an electronic envelope having a process ID. The apparatus further comprising means for processing the envelopes, means for generating a response message, and means for attaching a reply envelope to the response message, wherein the reply envelope comprises a target process ID.

In another aspect, a processor receiving a request message, wherein the request message comprises an electronic envelopes having a process ID, the processor further processing the envelopes, generating a response message, and the processor attaching a reply envelope to the response message, wherein the reply envelope comprises a target process ID.

A more complete appreciation of all the advantages and scope of the aspect can be obtained from the accompanying drawings, the description and the appended claims.

### BRIEF DESCRIPTION OF THE DRAWINGS

FIG. 1 illustrates a network diagram of an exemplary communications system;

FIG. 2 illustrates an exemplary access terminal;

FIG. 3 illustrates an exemplary access point;

FIG. 4A illustrates a flow of a routine according to an aspect of some embodiments

FIG. 4B illustrates a flow of a routine according to another aspect of some embodiments

FIG. 5 illustrates a flow of a routine under the control of a process that is selected as the process that will transmit a request message to another entity

FIG. 6 illustrates a flow of a routine a process that is not selected as the process that will transmit a request message to another entity; and

FIG. 7 a flow of a routine executed by the processor of an external device.

FIG. 8A and FIG. 8B illustrates the use of one or more modules to carry out the methodologies 800 and 850 according to an aspect of some embodiments.

### DETAILED DESCRIPTION

This aspect relates to communications system and, more particularly, to methods and apparatus for supporting quality of service differentiation between traffic flows in a communication system

This aspect relates to communications system and, more particularly, to methods and apparatus for supporting quality of service differentiation between traffic flows in a communication system

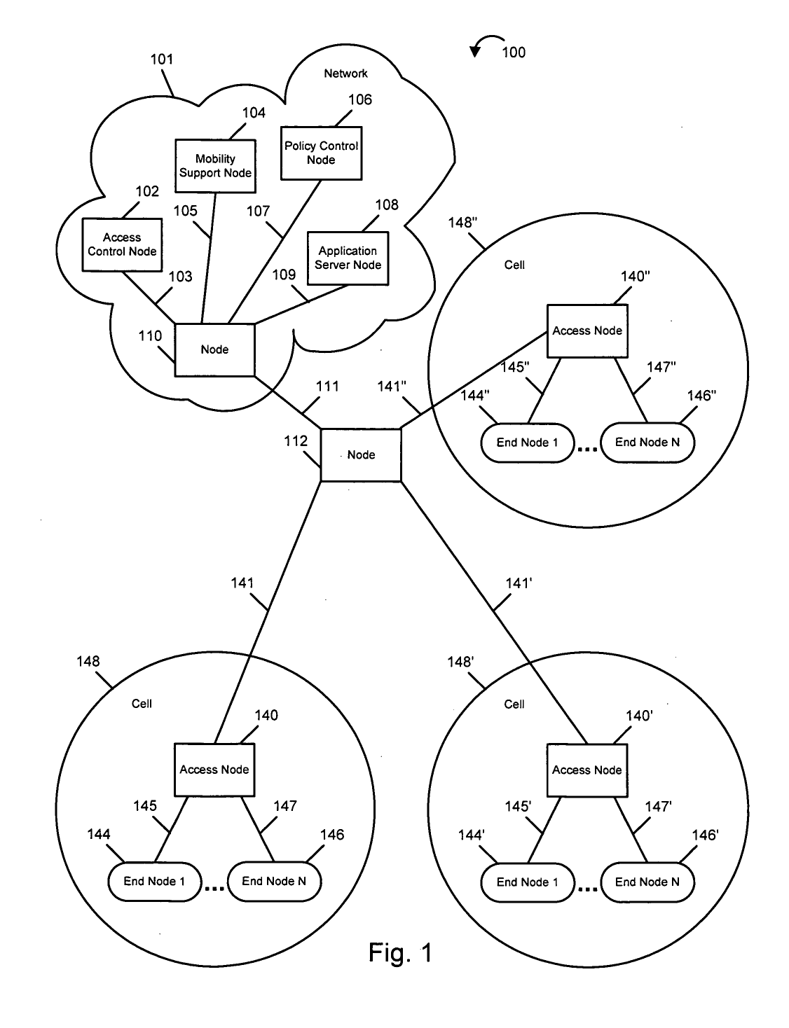

FIG. 1 illustrates an exemplary communication system 100 implemented in accordance with an aspect, e.g., a cellular communication network, which comprises a plurality of nodes interconnected by communications links. The network may use Orthogonal Frequency Division Multiplexing (OFDM) signals to communicate information over wireless links. However, other types of signals, e.g., Code Division Multiple Access (CDMA) signals or Time Division Multiple Access (TDMA) signals, might be used instead. Nodes in the exemplary communication system 100 exchange information using signals, e.g., messages, based on communication protocols, e.g., the Internet Protocol (IP). The communications links of the system 100 may be implemented, for example, using wires, fiber optic cables, and/or wireless communications techniques. The exemplary communication system 100 includes a plurality of end nodes (also referred to as access terminals) 144, 146, 144′, 146′, 144″, 146″, which access the communication system via a plurality of access nodes (also referred to as access points) 140, 140′, 140″. The access terminals 144, 146, 144′, 146′, 144″, 146″ may be, e.g., wireless communication devices or terminals, and the access points 140, 140′, 140″ may be, e.g., wireless access routers or base stations. The exemplary communication system 100 also includes a number of other nodes 102, 104, 106, 108, 110, and 112, used to provide interconnectivity or to provide specific services or functions.

The FIG. 1 exemplary system 100 depicts a network 101 that includes an access control node 102, a mobility support node 104, a policy control node 106, and an application server node 108, all of which are connected to an intermediate network node 110 by a corresponding network link 103, 105, 107, and 109, respectively. In some embodiments, the access control node, e.g., a Remote Authentication Dial In User Service (RADIUS) or Diameter server, supports authentication, authorization, and/or accounting of access terminals and/or services associated with access terminals. In some embodiments, the mobility support node, e.g., a Mobile IP home agent and/or context transfer server, supports mobility, e.g., handoff, of access terminals between access points, e.g., via redirection of traffic to/from access terminals and/or transfer of state associated with access terminals between access points. In some embodiments, the policy control node, e.g., a policy server or Policy Decision Point (PDP), supports policy authorization for services or application layer sessions. In some embodiments, the application server node, e.g., a Session Initiation Protocol server, streaming media server, or other application layer server, supports session signaling for services available to access terminals and/or provides services or content available to access terminals.

The intermediate network node 110 in the network 101 provides interconnectivity to network nodes that are external from the perspective of the network 101 via network link 111. Network link 111 is connected to another intermediate network node 112, which provides further connectivity to a plurality of access points 140, 140′, 140″ via network links 141, 141′, 141″, respectively.

Each access point 140, 140′, 140″ is depicted as providing connectivity to a plurality of N access terminals (144, 146), (144′, 146′), (144″, 146″), respectively, via corresponding access links (145, 147), (145′, 147′), (145″, 147″), respectively. In the exemplary communication system 100, each access point 140, 140′, 140″ is depicted as using wireless technology, e.g., wireless access links, to provide access. A radio coverage area, e.g., communications cell, 148, 148′, 148″ of each access point 140, 140′, 140″, respectively, is illustrated as a circle surrounding the corresponding access point.

The exemplary communication system 100 is subsequently used as a basis for the description of various embodiments. Alternative embodiments of the aspect include various network topologies, where the number and type of nodes (including network nodes, access points, access terminals, as well as various control, support, and server nodes), the number and type of links, and the interconnectivity between various nodes may differ from that of the exemplary communication system 100 depicted in FIG. 1.

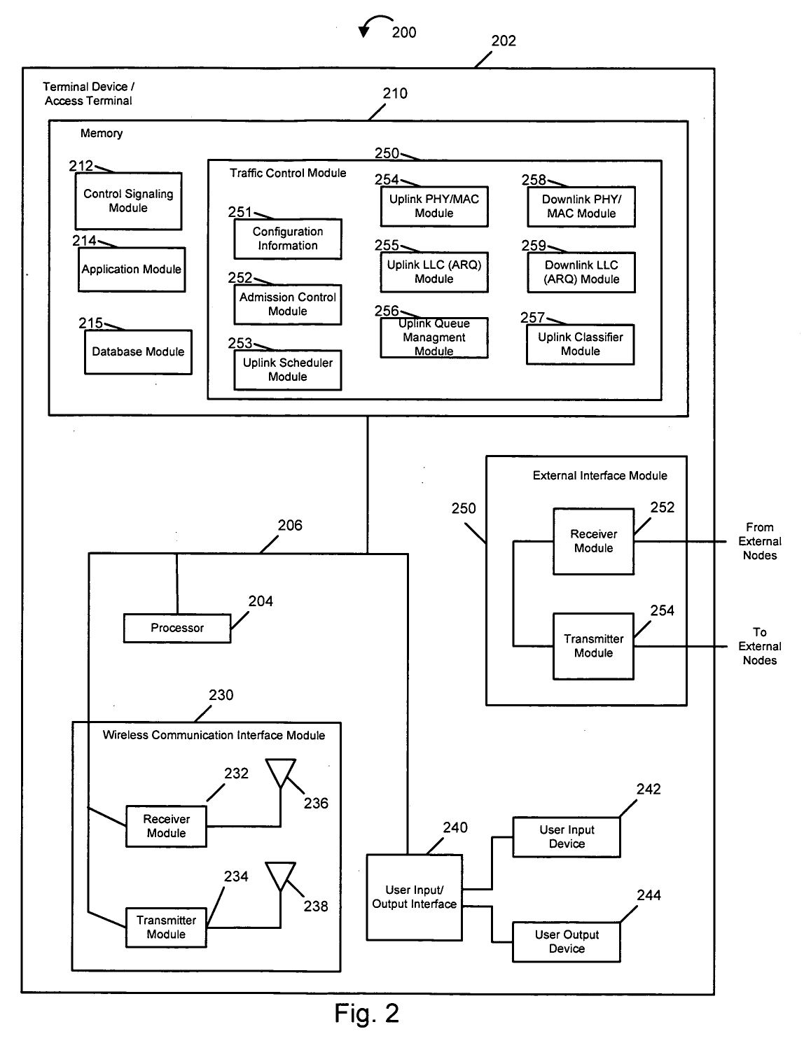

FIG. 2 provides a detailed illustration of an exemplary access terminal 200, e.g., wireless terminal. The exemplary access terminal 200, depicted in FIG. 2, is a detailed representation of an apparatus that may be used as any one of the access terminals 144, 146, 144′, 146′, 144″, 146″, depicted in FIG. 1. According to an aspect, in the FIG. 2 embodiment, the access terminal 200 includes a processor 204, a wireless communication interface module 230, a user input/output interface 240 and memory 210 coupled together by bus 206. Accordingly, via bus 206 the various components of the access terminal 200 can exchange information, signals and data. The components 204, 206, 210, 230, 240 of the access terminal 200 are located inside a housing 202.

The wireless communication interface module 230 provides a mechanism by which the internal components of the access terminal 200 can send and receive signals to/from external devices and network nodes, e.g., access points. The wireless communication interface module 230 includes, e.g., a receiver module 232 with a corresponding receiving antenna 236 and a transmitter module 234 with a corresponding transmitting antenna 238 used for coupling the access terminal 200 to other network nodes, e.g., via wireless communications channels.

The exemplary access terminal 200 also includes a user input device 242, e.g., keypad, and a user output device 244, e.g., display, which are coupled to bus 206 via the user input/output interface 240. Thus, user input/output devices 242, 244 can exchange information, signals and data with other components of the access terminal 200 via user input/output interface 240 and bus 206. The user input/output interface 240 and associated devices 242, 244 provide a mechanism by which a user can operate the access terminal 200 to accomplish various tasks. In particular, the user input device 242 and user output device 244 provide the functionality that allows a user to control the access terminal 200 and applications, e.g., modules, programs, routines and/or functions, that execute in the memory 210 of the access terminal 200.

The processor 204 under control of various modules, e.g., routines, included in memory 210 controls operation of the access terminal 200 to perform various signaling and processing. The modules included in memory 210 are executed on startup or as called by other modules. Modules may exchange data, information, and signals when executed. Modules may also share data and information when executed. In the FIG. 2 embodiment, the memory 210 of access terminal 200 of the includes a control signaling module 212, an application module 214, and a traffic control module 250, which further includes configuration information 251 and various additional modules 252, 253, 254, 255, 256, 257, 258, and 259.

The control signaling module 212 controls processing relating to receiving and sending signals, e.g., messages, for controlling operation and/or configuration of various aspects of the access terminal 200 including, e.g., the traffic control module 250 as well as the configuration information 251 and the various additional modules included therein 252, 253, 254, 255, 256, 257, 258, and 259. In some embodiments of the, the control signaling module 212 includes state information, e.g., parameters, status and/or other information, relating to operation of the access terminal 200 and/or one or more signaling protocols supported by the control signaling module 212. In particular, the control signaling module 212 may include configuration information, e.g., access terminal identification information and/or parameter settings, and operational information, e.g., information about current processing state, status of pending message transactions, etc.

The application module 214 controls processing and communications relating to one or more applications supported by the access terminal 200. In some embodiments of the aspect, application module 214 processing includes tasks relating to input/output of information via the user input/output interfaces 240, manipulation of information associated with an application, and/or receiving or sending signals, e.g., messages, associated with an application. In some embodiments, the application module 214 includes state information, e.g., parameters, status and/or other information, relating to operation of one or more applications supported by the application module 214. In particular, the application module 214 may include configuration information, e.g., user identification information and/or parameter settings, and operational information, e.g., information about current processing state, status of pending responses, etc. Applications supported by the application module 214 include, e.g., Voice over IP (VoIP), web browsing, streaming audio/video, instant messaging, file sharing, gaming, etc.

The database module 215 holds the information about the processes according to an aspect of some embodiments. For example, the database module 215 is used to storing the designated transmit process, an event look-up table, process registration information, a temporary holding place for envelopes, parameter valued, etc.

The traffic control module 250 controls processing relating to receiving and sending data information, e.g., messages, packets, and/or frames, via the wireless communication interface module 230. The exemplary traffic control module includes configuration information 251 as well as various additional modules 252, 253, 254, 255, 256, 257, 258, and 259 that control various aspects of quality of service for packets and/or traffic flows, e.g., associated sequences of packets. In some embodiments, the traffic control module 250 includes state information, e.g., parameters, status and/or other information, relating to operation of the access terminal 200, the traffic control module 250, and/or one or more of the various additional modules included therein 252, 253, 254, 255, 256, 257, 258, and 259. The configuration information 251, e.g., parameter settings, determines, affects and/or prescribes operation of the traffic control module 250 and/or the various additional modules included therein 252, 253, 254, 255, 256, 257, 258, and 259. The various additional modules are included, in some embodiments, to perform particular functions and operations as needed to support specific aspects of traffic control. In various embodiments, modules may be omitted and/or combined as needed depending on the functional requirements of traffic control. A description of each additional module included in the exemplary traffic control module 250 follows.

The admission control module 252 maintains information relating to resource utilization/availability and determines if sufficient resources are available to support the quality of service requirements of particular traffic flows. Resource availability information maintained by the admission control module 252 includes, e.g., packet and/or frame queuing capacity, scheduling capacity, as well as processing and memory capacity needed to support one or more traffic flows. The control signaling module 212, application module 214, and/or other modules included in the access terminal 200 may, and in some embodiments do, query the admission control module 252 to determine if sufficient resources are available to support a new or modified traffic flow, where the admission control determination is a function of the quality of service requirements of the particular traffic flow and/or the available resources. The configuration information 251 may, and in some embodiments does, include configuration information, e.g., parameters settings, that affect the operation of the admission control module 252, e.g., an admission control threshold value that indicates the percentage of resource that may be allocated prior to rejecting additional requests.

The uplink scheduler module 253 controls processing relating to transmission scheduling, e.g., order and/or timing, and allocation of transmission resources, e.g., information coding rate, transmission time slots, and/or transmission power, for data information, e.g., messages, packets, and/or frames, to be sent via the wireless interface module 230, e.g., from the access terminal 200 to an access point. The uplink scheduler module 253 may, and in some embodiments does, schedule transmissions and allocate transmission resources as a function of the quality of service requirements and/or constraints associated with one or more traffic flows. The configuration information 251 may, and in some embodiments does, include configuration information, e.g., parameters settings, that affect the operation of the uplink scheduler module 253, e.g., a priority, rate bound, latency bound, and/or sharing weight associated with one or more traffic flows. In some embodiments of the aspect, scheduling and/or resource allocation operations performed by the uplink scheduler module 253 are additionally a function of channel conditions and other factors, e.g., power budget.

The uplink PHY/MAC module 254 controls physical (PHY) layer and Media Access Control (MAC) layer processing relating to sending data information, e.g., messages, packets, and/or frames, via the wireless communication interface module 230, e.g., from the access terminal 200 to an access point. In some embodiments of the aspect, operation of the uplink PHY/MAC module 254 includes both sending and receiving control information, e.g., signals or messages, to coordinate sending of data information, e.g., messages, packets, or frames. The configuration information 251 may, and in some embodiments does, include configuration information, e.g., parameters settings, that affect the operation of the uplink PHY/MAC module 254, e.g., a frequency, band, channel, spreading code or hoping code to be used for transmissions, an identifier associated with the access terminal 200, a request dictionary prescribing use of an assignment request channel, etc.

The uplink Logical Link Control (ARQ) module 255 controls Logical Link Control (LLC) layer processing relating to sending data information, e.g., messages, packets, and/or frames, via the wireless communication interface module 230, e.g., from the access terminal 200 to an access point. The uplink LLC (ARQ) module 255 includes processing associated with Automatic Repeat Request (ARQ) capabilities, e.g., retransmission of lost packets or frames. In some embodiments of the aspect, the uplink LLC (ARQ) module 255 further includes processing relating to the addition of an LLC header and/or trailer to higher layer messages, e.g., packets, to provide additional functionality, e.g., multi-protocol multiplexing/demultiplexing via a type field or error detection via a checksum field. The uplink LLC (ARQ) module 255 may also, and in some embodiments does, perform fragmentation of higher layer messages, e.g., packets, into multiple sub-portions, e.g., frames to be sent by the uplink PHY/MAC module 254. The configuration information 251 may, and in some embodiments does, include configuration information, e.g., parameters settings, that affect the operation of the uplink LLC (ARQ) module 255, e.g., an ARQ window size, maximum number of retransmissions, a discard timer, etc.

The uplink queue management module 256 maintains information and controls processing relating to storage of data information, e.g., messages, packets, and/or frames, to be sent via the wireless communication interface module 230, e.g., from the access terminal 200 to an access point. The uplink queue management module 256 may, and in some embodiments does, control storage of data information awaiting transmission and maintain state information regarding data information awaiting transmission on a per traffic flow basis, e.g., packets associated with each traffic flow may be stored in separate queues. In some embodiments of the aspect, the uplink queue management module 256 supports a variety of queue management techniques and/or capabilities, e.g., head drop, tail drop, as well as various Active Queue Management (AQM) mechanisms such as Random Early Detection (RED). The configuration information 251 may, and in some embodiments does, include configuration information, e.g., parameters settings, that affect the operation of the uplink queue management module 256, e.g., a queue limit, drop strategy, and/or AQM thresholds associated with one or more traffic flows.

The uplink classifier module 257 controls processing relating to identification of data information, e.g., messages, packets, and/or frames, as belonging to particular traffic flows prior to being sent via the wireless communication interface module 230, e.g., from the access terminal 200 to an access point. In some embodiments of the aspect, messages, packets, and/or frames to be sent via the wireless communication interface module 230 are classified as belonging to one of a variety of traffic flows by the uplink classifier module 257 based on inspection of one or more header and/or payload fields. The results of classification by the uplink classifier module 257 may, and in some embodiments do, affect the treatment of the classified data information, e.g., messages, packets, and/or frames, by the uplink queue management module 256 and other modules 253, 254, 255, e.g., the results may determine a particular queue the message, packet, and/or frame will be associated with for storage and further affect subsequent processing such as scheduling. The configuration information 251 may, and in some embodiments does, include configuration information, e.g., parameters settings, that affect the operation of the uplink classifier module 257, e.g., a set of one or more classifier filter rules that prescribe criteria used to associate data information, e.g., messages, packets, and/or frames, as belonging to one or more traffic flows.

The downlink PHY/MAC module 258 controls PHY layer and MAC layer processing relating to receiving data information, e.g., packets and/or frames, via the wireless communication interface module 230, e.g., from an access point to the access terminal 200. In some embodiments of the aspect, operation of the downlink PHY/MAC module 258 includes both sending and receiving control information, e.g., signals or messages, to coordinate receiving of data information, e.g., messages, packets, or frames. The configuration information 251 may, and in some embodiments does, include configuration information, e.g., parameters settings, that affect the operation of the downlink PHY/MAC module 258, e.g., a frequency, band, channel, spreading code or hoping code to be used for reception, an identifier associated with the access terminal 200, etc.

The downlink LLC (ARQ) module 259 controls LLC layer processing relating to receiving data information, e.g., packets and/or frames, via the wireless communication interface module 230, e.g., from an access point to the access terminal 200. The downlink LLC (ARQ) module 259 includes processing associated with ARQ capabilities, e.g., retransmission of lost packets or frames. In some embodiments of the aspect, the downlink LLC (ARQ) module 259 further includes processing relating to an LLC header and/or trailer that encapsulates higher layer messages, e.g., packets, which provides additional functionality, e.g., multi-protocol multiplexing/demultiplexing via a type field or error detection via a checksum field. The downlink LLC (ARQ) module 259 may also, and in some embodiments does, perform reassembly of frames received by the downlink PHY/MAC module 258 into higher layer messages, e.g., packets. The configuration information 251 may, and in some embodiments does, include configuration information, e.g., parameters settings, that affect the operation of the downlink LLC (ARQ) module 259, e.g., an ARQ window size, maximum number of retransmissions, a discard timer, etc.

The external interface module 250 controls the data received and transmitted to one or more external devices (external nodes). The external interface module 250 comprises a receiver module 252 for receiving information from an external device. The receiver module interface may be an antenna, a USB slot, Ethernet slot, etc. In aspect, the receiver module may also comprise a set of RX modules (RX processor, Demodulator, decryptor, etc.) for receiving a wireless signal, data packets and messages over the air. The external interfaces module 250, further comprises an transmitter module 254. In an aspect, the transmitter module 254 comprises a set of TX modules (TX processor, Modulator, encryptor, etc.) for transmitting a wireless signal, data packets and message over the air. In an aspect, the USB slot, Ethernet slot, etc. may be used to wirelessly communicate with the external devices.

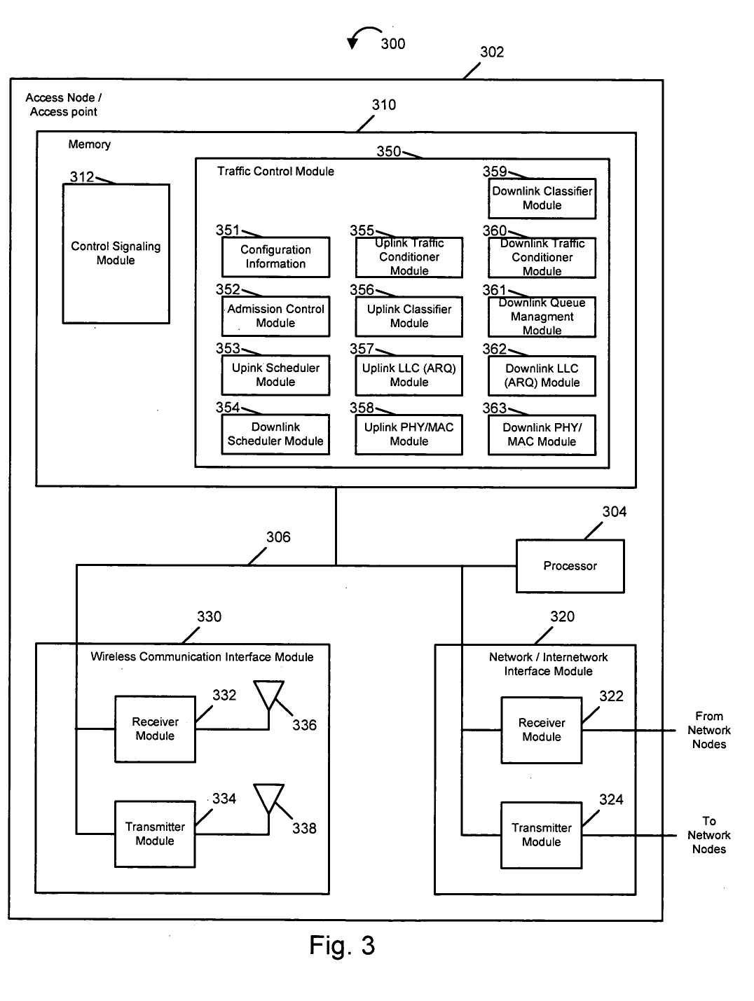

FIG. 3 provides a detailed illustration of an exemplary access point 300 implemented in accordance with the aspect of some embodiments. The exemplary access point 300, depicted in FIG. 3, is a detailed representation of an apparatus that may be used as any one of the access points 140, 140′, 140″ depicted in FIG. 1. In the FIG. 3 embodiment, the access point 300 includes a processor 304, memory 310, a network/internetwork interface module 320 and a wireless communication interface module 330, coupled together by bus 306. Accordingly, via bus 306 the various components of the access point 300 can exchange information, signals and data. The components 304, 306, 310, 320, 330 of the access point 300 are located inside a housing 302.

The network/internetwork interface module 320 provides a mechanism by which the internal components of the access point 300 can send and receive signals to/from external devices and network nodes. The network/internetwork interface module 320 includes, a receiver module 322 and a transmitter module 324 used for coupling the node 300 to other network nodes, e.g., via copper wires or fiber optic lines. The wireless communication interface module 330 also provides a mechanism by which the internal components of the access point 300 can send and receive signals to/from external devices and network nodes, e.g., access terminals. The wireless communication interface module 330 includes, e.g., a receiver module 332 with a corresponding receiving antenna 336 and a transmitter module 334 with a corresponding transmitting antenna 338. The wireless communication interface module 330 is used for coupling the access point 300 to other nodes, e.g., via wireless communication channels.

The processor 304 under control of various modules, e.g., routines, included in memory 310 controls operation of the access point 300 to perform various signaling and processing. The modules included in memory 310 are executed on startup or as called by other modules. Modules may exchange data, information, and signals when executed. Modules may also share data and information when executed. In the FIG. 3 embodiment, the memory 310 of access point 300 of the includes a control signaling module 312 and a traffic control module 350, which further includes configuration information 351 and various additional modules 352, 353, 354, 355, 356, 357, 358, 359, 360, 361, 362, and 363.

The control signaling module 312 controls processing relating to receiving and sending signals, e.g., messages, for controlling operation and/or configuration of various aspects of the access point 300 including, e.g., the traffic control module 350 as well as the configuration information 351 and the various additional modules included therein 352, 353, 354, 355, 356, 357, 358, 359, 360, 361, 362, and 363. In some embodiments of the aspect, the control signaling module 312 includes state information, e.g., parameters, status and/or other information, relating to operation of the access point 300 and/or one or more signaling protocols supported by the control signaling module 312. In particular, the control signaling module 312 may include configuration information, e.g., access point identification information and/or parameter settings, and operational information, e.g., information about current processing state, status of pending message transactions, etc.

The traffic control module 350 controls processing relating to receiving and sending data information, e.g., messages, packets, and/or frames, via the wireless communication interface module 330. The exemplary traffic control module includes configuration information 351 as well as various additional modules 352, 353, 354, 355, 356, 357, 358, 359, 360, 361, 362, and 363 that control various aspects of quality of service for packets and/or traffic flows, e.g., associated sequences of packets. In some embodiments of the aspect, the traffic control module 350 includes state information, e.g., parameters, status and/or other information, relating to operation of the access point 300, the traffic control module 350, and/or one or more of the various additional modules included therein 352, 353, 354, 355, 356, 357, 358, 359, 360, 361, 362, and 363. The configuration information 351, e.g., parameter settings, determines, affects and/or prescribes operation of the traffic control module 350 and/or the various additional modules included therein 352, 353, 354, 355, 356, 357, 358, 359, 360, 361, 362, and 363. The various additional modules are included, in some embodiments, to perform particular functions and operations as needed to support specific aspects of traffic control. In various embodiments of the aspect, modules may be omitted and/or combined as needed depending on the functional requirements of traffic control. A description of each additional module included in the exemplary traffic control module 350 follows.

The admission control module 352 maintains information relating to resource utilization/availability and determines if sufficient resources are available to support the quality of service requirements of particular traffic flows. Resource availability information maintained by the admission control module 352 includes, e.g., packet and/or frame queuing capacity, scheduling capacity, as well as processing and memory capacity needed to support one or more traffic flows. The control signaling module 312 and/or other modules included in the access point 300 may, and in some embodiments do, query the admission control module 352 to determine if sufficient resources are available to support a new or modified traffic flow, where the admission control determination is a function of the quality of service requirements of the particular traffic flow and/or the available resources. The configuration information 351 may, and in some embodiments does, include configuration information, e.g., parameters settings, that affect the operation of the admission control module 352, e.g., an admission control threshold value that indicates the percentage of resource that may be allocated prior to rejecting additional requests.

The uplink scheduler module 353 controls processing relating to transmission scheduling, e.g., order and/or timing, and allocation of transmission resources, e.g., information coding rate, transmission time slots, and/or transmission power, for data information, e.g., messages, packets, and/or frames, to be sent from one or more access terminals to the access point via the wireless interface module 330. The uplink scheduler module 353 may, and in some embodiments does, schedule transmissions and allocate transmission resources as a function of the quality of service requirements and/or constraints associated with one or more traffic flows and/or one or more access terminals. The configuration information 351 may, and in some embodiments does, include configuration information, e.g., parameters settings, that affect the operation of the uplink scheduler module 353, e.g., a priority, rate bound, latency bound, and/or sharing weight associated with one or more traffic flows and/or access terminals. In some embodiments of the aspect, scheduling and/or resource allocation operations performed by the uplink scheduler module 353 are additionally a function of channel conditions and other factors, e.g., power budget.

The downlink scheduler module 354 controls processing relating to transmission scheduling, e.g., order and/or timing, and allocation of transmission resources, e.g., information coding rate, transmission time slots, and/or transmission power, for data information, e.g., messages, packets, and/or frames, to be sent from the access point 300 to one or more access terminals via the wireless interface module 330. The downlink scheduler module 354 may, and in some embodiments does, schedule transmissions and allocate transmission resources as a function of the quality of service requirements and/or constraints associated with one or more traffic flows and/or one or more access terminals. The configuration information 351 may, and in some embodiments does, include configuration information, e.g., parameters settings, that affect the operation of the downlink scheduler module 354, e.g., a priority, rate bound, latency bound, and/or sharing weight associated with one or more traffic flows and/or access terminals. In some embodiments of the aspect, scheduling and/or resource allocation operations performed by the downlink scheduler module 354 are additionally a function of channel conditions and other factors, e.g., power budget.

The uplink traffic conditioner module 355 controls processing relating to traffic conditioning, e.g., metering, marking, policing, etc., for data information, e.g., messages, packets, and/or frames, received via the wireless interface module 330, e.g., from an access terminal to the access point 300. The uplink traffic conditioner module 355 may, and in some embodiments does, condition traffic, e.g., meter, mark and/or police, as a function of the quality of service requirements and/or constraints associated with one or more traffic flows and/or one or more access terminals. The configuration information 351 may, and in some embodiments does, include configuration information, e.g., parameters settings, that affect the operation of the uplink traffic conditioner module 355, e.g., a rate bound, and/or marking value associated with one or more traffic flows and/or access terminals.

The uplink classifier module 356 controls processing relating to identification of data information, e.g., messages, packets, and/or frames, received via the wireless interface module 330, e.g., from an access terminal to the access point 300, as belonging to particular traffic flows prior to being processed by uplink traffic conditioner module 355. In some embodiments of the aspect, messages, packets, and/or frames received via the wireless communication interface module 330 are classified as belonging to one of a variety of traffic flows by the uplink classifier module 356 based on inspection of one or more header and/or payload fields. The results of classification by the uplink classifier module 356 may, and in some embodiments do, affect the treatment of the classified data information, e.g., messages, packets, and/or frames, by the uplink traffic conditioner module 355, e.g., the results may determine a particular data structure or state machine the message, packet, and/or frame will be associated with and further affect subsequent processing such as metering, marking, and/or policing. The configuration information 351 may, and in some embodiments does, include configuration information, e.g., parameters settings, that affect the operation of the uplink classifier module 356, e.g., a set of one or more classifier filter rules that prescribe criteria used to associate data information, e.g., messages, packets, and/or frames, as belonging to one or more traffic flows.

The uplink LLC (ARQ) module 357 controls LLC layer processing relating to receiving data information, e.g., packets and/or frames, via the wireless communication interface module 330, e.g., from an access terminal to the access point 300. The uplink LLC (ARQ) module 357 includes processing associated with ARQ capabilities, e.g., retransmission of lost packets or frames. In some embodiments of the aspect, the uplink LLC (ARQ) module 357 further includes processing relating to an LLC header and/or trailer that encapsulates higher layer messages, e.g., packets, which provides additional functionality, e.g., multi-protocol multiplexing/demultiplexing via a type field or error detection via a checksum field. The uplink LLC (ARQ) module 357 may also, and in some embodiments does, perform reassembly of frames received by the uplink PHY/MAC module 358 into higher layer messages, e.g., packets. The configuration information 251 may, and in some embodiments does, include configuration information, e.g., parameters settings, that affect the operation of the uplink LLC (ARQ) module 357, e.g., an ARQ window size, maximum number of retransmissions, a discard timer, etc.

The uplink PHY/MAC module 358 controls PHY layer and MAC layer processing relating to receiving data information, e.g., packets and/or frames, via the wireless communication interface module 330, e.g., from an access terminal to the access point 300. In some embodiments of the aspect, operation of the uplink PHY/MAC module 358 includes both sending and receiving control information, e.g., signals or messages, to coordinate receiving of data information, e.g., messages, packets, or frames. The configuration information 351 may, and in some embodiments does, include configuration information, e.g., parameters settings, that affect the operation of the uplink PHY/MAC module 358, e.g., a frequency, band, channel, spreading code or hoping code to be used for reception, an identifier associated with the access point 300, etc.

The downlink classifier module 359 controls processing relating to identification of data information, e.g., messages, packets, and/or frames, as belonging to particular traffic flows prior to being sent via the wireless communication interface module 330, e.g., from the access point 300 to an access terminal. In some embodiments of the aspect, messages, packets, and/or frames to be sent via the wireless communication interface module 330 are classified as belonging to one of a variety of traffic flows by the downlink classifier module 359 based on inspection of one or more header and/or payload fields. The results of classification by the downlink classifier module 359 may, and in some embodiments do, affect the treatment of the classified data information, e.g., messages, packets, and/or frames, by the downlink queue management module 361 and other modules 360, 362, 363, e.g., the results may determine a particular queue the message, packet, and/or frame will be associated with for storage and further affect subsequent processing such as scheduling. The configuration information 351 may, and in some embodiments does, include configuration information, e.g., parameters settings, that affect the operation of the downlink classifier module 359, e.g., a set of one or more classifier filter rules that prescribe criteria used to associate data information, e.g., messages, packets, and/or frames, as belonging to one or more traffic flows.

The downlink traffic conditioner module 360 controls processing relating to traffic conditioning, e.g., metering, marking, policing, etc., for data information, e.g., messages, packets, and/or frames, to be sent via the wireless interface module 330, e.g., from the access point 300 to an access terminal. The downlink traffic conditioner module 360 may, and in some embodiments does, condition traffic, e.g., meter, mark and/or police, as a function of the quality of service requirements and/or constraints associated with one or more traffic flows and/or one or more access terminals. The configuration information 351 may, and in some embodiments does, include configuration information, e.g., parameters settings, that affect the operation of the downlink traffic conditioner module 360, e.g., a rate bound, and/or marking value associated with one or more traffic flows and/or access terminals.

The downlink queue management module 361 maintains information and controls processing relating to storage of data information, e.g., messages, packets, and/or frames, to be sent via the wireless communication interface module 330, e.g., from the access point 300 to an access terminal. The downlink queue management module 361 may, and in some embodiments does, control storage of data information awaiting transmission and maintain state information regarding data information awaiting transmission on a per traffic flow basis, e.g., packets associated with each traffic flow may be stored in separate queues. In some embodiments of the aspect, the downlink queue management 361 module supports a variety of queue management techniques and/or capabilities, e.g., head drop, tail drop, as well as various AQM mechanisms such as RED. The configuration information 351 may, and in some embodiments does, include configuration information, e.g., parameters settings, that affect the operation of the downlink queue management module 361, e.g., a queue limit, drop strategy, and/or AQM thresholds associated with one or more traffic flows.

The downlink LLC (ARQ) module 362 controls LLC layer processing relating to sending data information, e.g., messages, packets, and/or frames, via the wireless communication interface module 330, e.g., from the access point 300 to an access terminal. The downlink LLC (ARQ) module 362 includes processing associated with ARQ capabilities, e.g., retransmission of lost packets or frames. In some embodiments of the aspect, the downlink LLC (ARQ) module 362 further includes processing relating to the addition of an LLC header and/or trailer to higher layer messages, e.g., packets, to provide additional functionality, e.g., multi-protocol multiplexing/demultiplexing via a type field or error detection via a checksum field. The downlink LLC (ARQ) module 362 may also, and in some embodiments does, perform fragmentation of higher layer messages, e.g., packets, into multiple sub-portions, e.g., frames to be sent by the downlink PHY/MAC module 363. The configuration information 351 may, and in some embodiments does, include configuration information, e.g., parameters settings, that affect the operation of the downlink LLC (ARQ) module 362, e.g., an ARQ window size, maximum number of retransmissions, a discard timer, etc.

The downlink PHY/MAC module 363 controls PHY layer and MAC layer processing relating to sending data information, e.g., messages, packets, and/or frames, via the wireless communication interface module 330, e.g., from the access point 300 to an access terminal. In some embodiments of the aspect, operation of the downlink PHY/MAC module 363 includes both sending and receiving control information, e.g., signals or messages, to coordinate sending of data information, e.g., messages, packets, or frames. The configuration information 351 may, and in some embodiments does, include configuration information, e.g., parameters settings, that affect the operation of the downlink PHY/MAC module 363, e.g., a frequency, band, channel, spreading code or hoping code to be used for transmissions, an identifier associated with the access point 300, etc.

In aspect, an envelope scheme is used to avoid unnecessary handshake communication that tie up valuable resources. During the operation of the wireless communication system according to an aspect, one or more processes are being independently and asynchronously executed by the processor. For example, a network access process, mobility management process, a QoS process, and a connection control protocol (CCP) process. Also, during the operation of the communication system, events occur that may require one or more the processes to transmit information to an external device (for example the base station) or to establish parameters. In an aspect, a connection establishment event, a handoff event, and QoS reservation events are pre-stored in memory. In an aspect, the events may be stored in memory of each node (base station, mobile terminal, host, wireless terminal, etc) at the start up. It should be noted that various other events and processes may be created by one skilled in the art without departing from the aspect of this embodiment.

In an aspect, for each event, one process may be designated as the process that will transmit and receive information from an external device and/or establish parameters. The designated process is considered as a transmit process and that process will transmit and receive messages from the external device. All other processes that are required to establish parameters will be considered as non-transmit process for a given event. In one aspect the transmit process is preconfigured and known by all the non-transmit processes and for all events. In another aspect the transmit process is preconfigured and known by all non-transmit processes on a per event basis. In another aspect, a different process may be designated as the transmit process in a dynamic way.

In an aspect, the Connection Control Protocol (CCP) is selected as the transmit process. All other processes that are required to transmit or to receive information will register with CCP process. The registration notifies the existence of each process to CCP process. In an aspect, the CCP process will generate a request message that will be transmitted to an external device. In an aspect the message is generated as a reaction to an event (e.g., a handoff or a connection establishment). All the non-transmit processes will attach an electronic envelope to the request message, wherein the request message capable of accepting one or more electronic envelopes.

In an aspect, an envelope comprises at least one envelope identification (ID), which identifies the process and comprises one or more objects. For example, the envelopes comprise a process identification identifying the requesting process (e.g., an EnvelopeID) and a list of required parameters or objects for the process (e.g., in ObjectID, Length, Value format). The number of objects per envelope may vary based the number of processes that require to establish parameters. In an aspect, each object may be an envelope comprising additional objects or parameter information such as type of parameter and length of parameters.

In another aspect of the some embodiments, the transmit process may be selected statically based one or more predetermined criteria, for example if a process that has already established physical resources with the external device. In this aspect, all other processes will generate the necessary envelope and attach the envelope to the currently identified transmit process.

In another aspect of some embodiments, a look-up table, that is pre-stored in the memory, may be used to designate the transmit process that will communicate with the external device. Also, the look-up table may be used to identify each processes that will generate and envelope and attach the envelope to the designated transmit process. In aspect, when an event occurs, each process may check the look-up table to determine if it the transmit process, a non-transmit process or no actions required. If determined that a process is a transmit process, set up resources, generate a request message, generate an envelope, if required, and accept envelopes from non-transmit processes. If determined that a process is a non-transmit process, then generate an envelope and attach it to a request message generated by the transmit process. In aspect, the processes may register with the transmit process prior to attaching the envelopes.

In another aspect of some embodiment, the transmit process may be permanently selected as a transmit process (even if that process does not need to transmit any information), wherein the transmit process may maintain resources periodically or throughout the operation of the communication. All other processes register with the transmit process and send information through the transmit process.

It should be noted that various other means may be employed to identify a process that will transmit a request message while other processes will attach information to the request message.

In an aspect, the transmit process (for example CCP) after transmitting the request message may receive a response message from the external entity. In another aspect, process other than the transmit process may receive the response. Generally, the transmit process will be the receive process for processing the response received from the external device as well as for processing unsolicited messages (initial messages in a transaction) by the external device. The response message may comprise a reply header, list of reply envelopes, an event or other information. Each reply envelope comprises a target process ID and one or more objects associated with establishing the parameters. In an aspect, the target process ID (e.g., Envelope IDs) identifies which process receives the attached envelope. In an aspect, upon receiving a reply from an external device (entity), the receive process will determine the content of the response message. If one or more envelope is embedded in the response message, then the receive process will distribute embedded envelope(s) to the appropriate processes. The envelopes are then processed by the respective processes.

The unsolicited message may comprise a request header, list of request envelopes, an event or other information. Each request envelope comprises a target process ID and one or more objects associated with establishing the parameters. In an aspect, the target process ID (e.g., Envelope IDs) identifies which process receives the attached envelope. In an aspect, upon receiving a request from an external device (entity), the receive process will determine the content of the request message. If one or more envelope is embedded in the request message, then the receive process will distribute embedded envelope(s) to the appropriate processes. The envelopes are then processed by the respective processes and a response message may also be generated.

In an aspect, if the response message triggers an event, then the receive process may notify all or a subset of processes by broadcasting the event to the processes. In an aspect, the received process may use the look-up table and broadcast the events only to those processes that would be affected by the event.

In an aspect, an event process may be independently and asynchronously executing along with other processes. The event notification process may be for processing events, wherein the receive process will forward all the events to the event notification process and event process will appropriately broadcast the events.

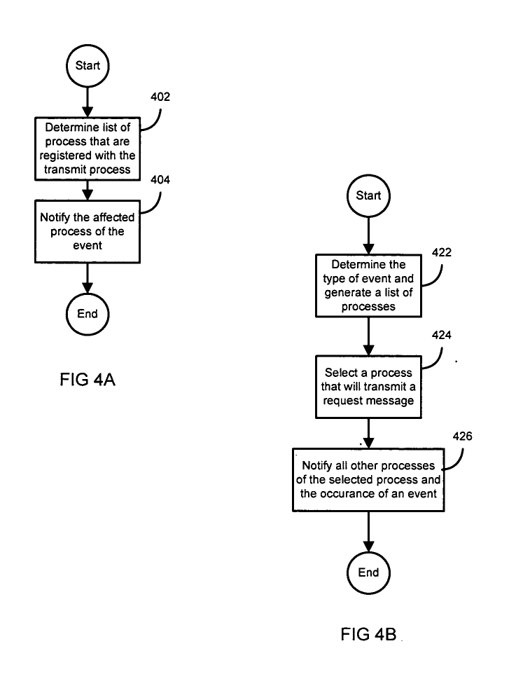

FIG. 4A illustrates a flow of a routine 400 according to an aspect of some embodiments. The processor 204 is configured to execute the routine upon a triggering of event, for example a handoff event. In an aspect, the CCP is designated as the transmit process. All other processes that will use the envelope scheme will register with CCP and await notification of an event. At block 402, the processor 204 is configured to execute a module to determine a list of processes that are affected by the triggering of the event. In an aspect, the processor 204 is configured to access the memory to determine the list of processes that are registered with the transmit process (e.g. CCP process). At block 404, the processor 204 is configured to execute a module to notify the affected processes of the event. The processor 204 may broadcast the occurrence of the event to all processes in the list of processes (for example, the processes that are registered with the CCP process). In an aspect, if the event is triggered by a message (e.g., a handoff request message) that includes envelopes, then at block 404, the notification may include the envelopes received in the message that triggered the event.

FIG. 4B illustrates a flow of a routine 420 according to another aspect of some embodiments. At 422, the processor 204 is configured to execute a module determine the type of event occurred. Also, block 422, the module is configured to generate a list of process that requires configuring of one or more parameters. In an aspect, the processor 204 coupled to memory will access the memory to look up the processes that are affected by the event. At block 424, the processor 204 is configured to execute a module that will select one of process from a list of processes that will transmit a request message to configure the parameters. In an aspect, the transmit process is selected based on the type of event that occurred. At block 426, the processor 204 is configured to execute a module that will notify all other processes (not selected for transmitting the request message) of the selected process and broadcast the occurrence of the event.

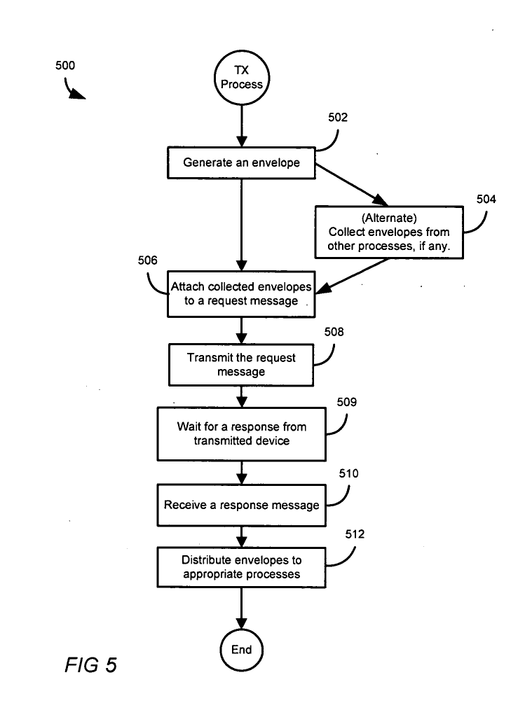

FIG. 5 illustrates a flow of a routine under the control of a process that is selected as the process that will transmit a request message to another entity. This routine may be applicable to any device in the system that communicates with any other device in system. For example, a wireless terminal that communicates with a base station, wherein the wireless terminal processor 204 and/or the base station processor 204 may be configured execute this routine. The processor 204 is configured to execute blocks 502-514. At 502, a module is executed to generate one or more electronic envelopes comprising all the necessary parameters (request for new, modification to the values of existing parameters, etc.). At block 506, a module is executed to attach envelopes from other processes. In another aspect of some embodiments, at block 504, the processor 204 executes a module that to collect and hold envelopes from received from other processes before attaching them to the request message. The envelopes may be collected and held in memory until its time to transmit the request message. At block 508, the processor 204 executes a module to transmit the request message to device that will assist in configuring the parameters, for example a base station. If the communication link is not setup, then at block 508, a communication link set up module will be executed prior to transmitting the request message.

At block 509, the processor 204 is configured to wait for a response from the base station. At block 510, the processor 204 is configured to receive a response message from the base station. At block 512, the processor 204 executes a module to extract envelopes contained in the response message, if any, and distribute them to the appropriate processes. For example, the received envelopes may be placed in memory and each process is notified that an envelope is received. In an aspect, the envelopes may indicate the process that receives the envelope, for example the Envelope_ID (e.g. process ID). In another aspect, the envelopes may be attached in the same position as in the request message and the processor 204 will determine by the index which process receives the envelope.

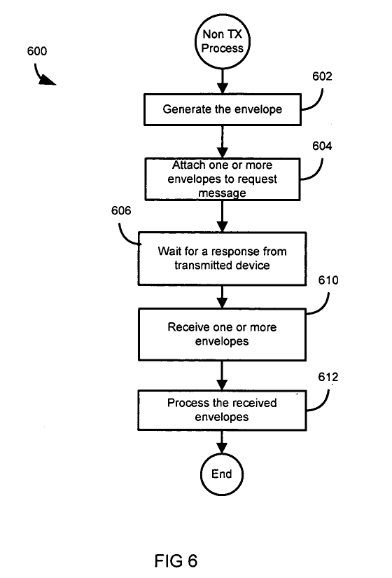

FIG. 6 illustrates a flow of a routine 600 under the control of a process that is not selected as the process that will transmit a request message to another entity. This routine may be applicable to any device in the system that communicates with any other device in system. For example, a wireless terminal that communicates with a base station, wherein the wireless terminal processor 204 and/or the base station processor 204 may be configured execute this routine. Prior to the execution of routine 600, the processor 204 determines that based on the event, this process needs to configure parameters and provides the identification of the process that will transmit a request message to base station. At block 602, the processor 204 executes a module to generate one or more electronic envelopes comprising all the necessary parameters (request for new, modification to the values of existing parameters, etc.). At block 604, upon generating the required electronic envelope, the processor 204 may either place them in memory for the process selected to extract or attached it the request message. At block 606, the routine is placed on wait state. At block 610, the processor 204 is configured to receive one or more electronic envelopes from the process selected for transmitting the request message. This generally described in FIG. 5 at block 512. At block 612, the processor 204 executes a module to process one or more received electronic envelopes at block 610.

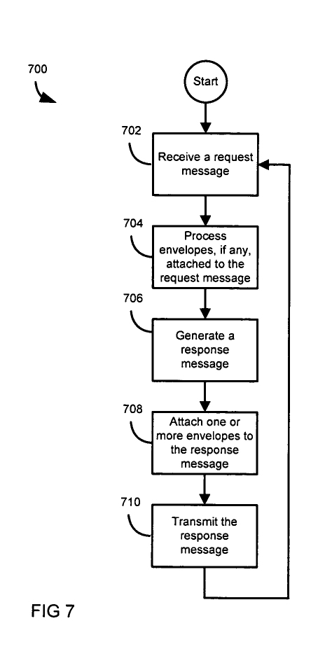

FIG. 7 illustrates a flow of a routine 700 executed by the processor. This routine is executed by each device in the communication system. As stated above, depending on the type of event, a device may transmit a request message or receive a request message comprising one or more electronic envelopes. The processor 204 and processor 304 are configured to execute the routine 700. For clarity, processor 204 will used to describe the methodology according to an aspect. At block 702, the processor 204 is configured to receive a request message. At block 704, the processor 204 may execute a module to extract electronic envelopes if attached to the request message. Thereafter, the processor 204 may execute a module to process one or more envelopes attached to the received request message. At block 706, the processor 204 is configured to generate a response message to the request message. The response message may comprise an envelope, a list of envelopes, one or more events or other messages. After processing the request message and envelopes and if determined that one more envelopes is required for one or more processes 204, at block 708, the processor generates the required electronic envelopes and attaches to the response message. At block 710, the processor 204 is configured to transmit the response message to the device that transmitted the request.

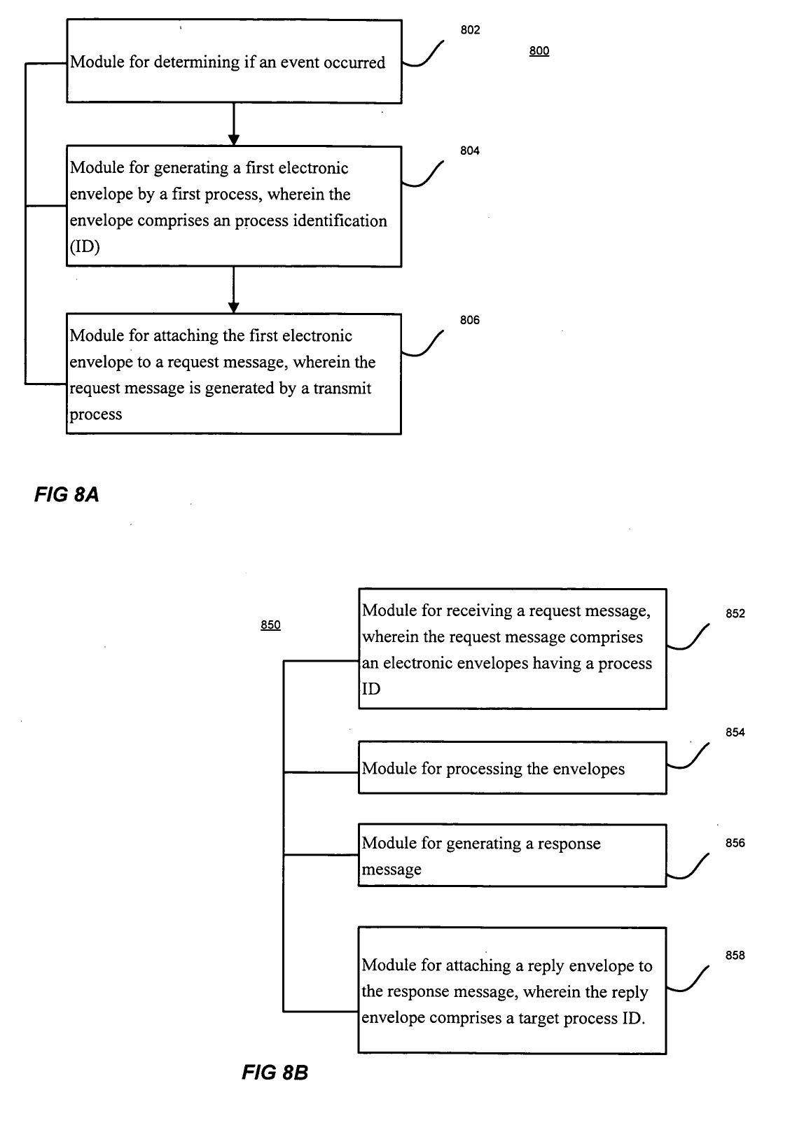

FIG. 8A and FIG. 8B illustrates the use of one or more modules to carry out the methodologies 800 and 850 according to an aspect of some embodiments. The modules referred to in FIG. 8A and FIG. 8B may be an electronic devices, processors, hardware devices, storage mediums, etc. or any combination thereof. Referring to FIG. 8A, in an aspect, an apparatus comprises means for determining if an event occurred. The apparatus also comprises means for generating a first electronic envelope by a first process, wherein the envelope comprises an process identification (ID) and means for attaching the first electronic envelope to a request message, wherein the request message is generated by a transmit process. The means for determining may be a module as described by 802 of FIG. 8A. The means for generating may be a module as described by 804 of FIG. 8A. and the means for attaching may comprise a module as described by 806 of FIG. 8A.

Referring to FIG. 8B, in another aspect, an apparatus comprises means for receiving a request message, wherein the request message comprises an electronic envelope having a process ID, wherein the means comprises a module as described by 852 of FIG. 8B. The apparatus further comprising means for processing the envelopes, wherein the means comprises a module as described by 854 of FIG. 8B. Also, means for generating a response message, wherein the means comprises a module as described by 856 of FIG. 8B, and means for attaching a reply envelope to the response message, wherein the reply envelope comprises a target process ID. The means for attaching comprises a module as described by 858 of FIG. 8B.

Messages described in the present patent application are stored in the memory of the nodes which generate and/or receive said messages in addition to the nodes through which said messages are communicated. Accordingly, in addition to being directed to methods and apparatus for generating, transmitting and using novel messages of aspects of some embodiments, the aspect is also directed to machine readable media, e.g., memory, which stores one or more of the novel messages of the type described and shown in the text and figures of the present application.

In various embodiments, nodes described herein are implemented using one or more modules to perform the steps corresponding to one or more methods of the aspect, for example, signal processing, message generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, compact disc, DVD, etc. to control a machine, e.g., general purpose computer with or without additional hardware, to implement all or portions of the above described methods, e.g., in one or more nodes. Accordingly, among other things, the aspect is directed to a machine-readable medium including machine executable instructions for causing a machine, e.g., processor and associated hardware, to perform one or more of the steps of the above-described method(s).

In various embodiments, nodes described herein are implemented using one or more modules to perform the steps corresponding to one or more methods, for example, signal processing, message generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium including machine executable instructions for causing a machine, e.g., processor and associated hardware, to perform one or more of the steps of the above-described method(s).

For example, access point 300 and access terminal 200 are configured to for implementing communication protocols/standards such as World Interoperability for Microwave Access (WiMAX), infrared protocols such as Infrared Data Association (IrDA), short-range wireless protocols/technologies, Bluetooth® technology, ZigBee® protocol, ultra wide band (UWB) protocol, home radio frequency (HomeRF), shared wireless access protocol (SWAP), wideband technology such as a wireless Ethernet compatibility alliance (WECA), wireless fidelity alliance (Wi-Fi Alliance), 802.11 network technology, public switched telephone network technology, public heterogeneous communications network technology such as the Internet, private wireless communications network, land mobile radio network, code division multiple access (CDMA), wideband code division multiple access (WCDMA), universal mobile telecommunications system (UMTS), advanced mobile phone service (AMPS), time division multiple access (TDMA), frequency division multiple access (FDMA), orthogonal frequency division multiple access (OFDMA), global system for mobile communications (GSM), single carrier (IX) radio transmission technology (RTT), evolution data only (EV-DO) technology, general packet radio service (GPRS), enhanced data GSM environment (EDGE), high speed downlink data packet access (HSPDA), analog and digital satellite systems, and any other technologies/protocols that may be used in at least one of a wireless communications network and a data communications network.

Numerous additional variations on the methods and apparatus of the aspects described above will be apparent to those skilled in the art in view of the above description of the aspect. Such variations are to be considered within the scope of the aspect. The methods and apparatus of the aspects may be, and in various embodiments are, used with OFDM, CDMA, TDMA or various other types of communications techniques which may be used to provide wireless communications links between access nodes and mobile nodes. In some embodiments the access nodes are implemented as base stations which establish communications links with mobile nodes using OFDM, CDMA and/or TDMA. In various embodiments the mobile nodes are implemented as notebook computers, PDAs, or other portable devices including receiver/transmitter circuits and logic and/or routines, for implementing the methods of the aspects described above.

What is claimed is:

1. A method of configuring parameters in a communication system, the method comprising:
determining if an event occurred;
generating a first electronic envelope by a first process, wherein the envelope comprises a process identification (ID); and
attaching the first electronic envelope to a request message, wherein the request message is generated by a transmit process.

2. The method as claimed in claim 1, the method further comprising transmitting the request message.

3. The method as claimed in claim 1, the method further comprising selecting the transmit process prior to generating the request message.

4. The method as claimed in claim 1, the method further comprising registering one or more process designated as non-transmit process.

5. The method as claimed in claim 4, the method further comprising broadcasting a notification that an event occurred to all the registered processes.

6. The method as claimed in claim 1, the method further comprising receiving a response message from an external device.

7. The method as claimed in claim 6, wherein
receiving the response message comprises of receiving one or more electronic envelopes from an external device, wherein the envelope comprises the process (ID); and
distributing the received envelope to process associated with the process (ID).

8. The method as claimed in claim 7, further comprising processing the received envelope.

9. The method as claimed in claim 6, wherein receiving the response message comprises receiving an event information.

10. The method as claimed in claim 9, further comprising broadcasting the received event information to one or more processes.

11. The method as claimed in claim 1, wherein generating the first electronic envelope comprises generating parameters as objects.

12. The method as claimed in claim 1, wherein attaching the first electronic envelope to a request message, wherein the request message is generated by CCP process.

13. The method as claimed in claim 1, wherein attaching the first electronic envelope to the request message comprises of attaching the first message to a connect request message.

14. The method as claimed in claim 1, wherein attaching the first electronic envelope to the request message comprises of attaching the first message to a handoff request message.

15. The method as claimed in claim 6, wherein receiving the response message comprises of receiving a connect response message.

16. The method as claimed in claim 6, wherein receiving the response message comprises of receiving a handoff response message.

17. An apparatus of configuring parameters in a communication system, the apparatus comprising:
means for determining if an event occurred;
means for generating a first electronic envelope by a first process, wherein the envelope comprises an process identification (ID); and
means for attaching the first electronic envelope to a request message, wherein the request message is generated by a transmit process.

18. The apparatus as claimed in claim 17, the apparatus further comprising means for transmitting the request message.

19. The apparatus as claimed in claim 17, the apparatus further comprising means for selecting the transmit process prior to generating the request message.

20. The apparatus as claimed in claim 17, the apparatus further comprising means for registering one or more process designated as non-transmit process.

21. The apparatus as claimed in claim 20, the apparatus further comprising means for broadcasting a notification that an event occurred to all the registered processes.

22. The apparatus as claimed in claim 17, the apparatus further comprising means for receiving a response message from an external device.

23. The apparatus as claimed in claim 22, wherein the response message comprises of receiving one or more electronic envelopes from an external device, wherein the envelope comprises the process (ID); and further comprising means for distributing the received envelope to a process associated with the process (ID).

24. The apparatus as claimed in claim 23, further comprising means for processing the received envelope.

25. The apparatus as claimed in claim 22, wherein the response message comprises an event information.

26. The apparatus as claimed in claim 25, further comprising means for broadcasting the received event information to one or more processes.

27. The apparatus as claimed in claim 17, wherein the first electronic envelope comprises one or more parameters as objects.

28. The apparatus as claimed in claim 17, wherein the first electronic envelope is generated by CCP process.

29. The apparatus as claimed in claim 17, wherein the first electronic envelope is attached to a connect request message.

30. The apparatus as claimed in claim 17, wherein the first electronic envelope is attached to a handoff request message.

31. The apparatus as claimed in claim 22, wherein the response message comprises a connect response message.

32. The apparatus as claimed in claim 22, wherein the response message comprises a handoff response message.

33. An apparatus of configuring parameters in a communication system, the apparatus comprising:
a processor, the processor determining if an event occurred; the processor generating a first electronic envelope by a first process, wherein the envelope comprises an process identification (ID); the processor attaching the first electronic envelope to a request message, wherein the request message is generated by a transmit process; and
a memory coupled to the processor and the memory used for storing the process ID.

34. The apparatus as claimed in claim 33, the processor further selecting the transmit process prior to generating the request message.

35. The apparatus as claimed in claim 33, the processor further registering one or more process designated as non-transmit process.

36. The apparatus as claimed in claim 35, the processor further broadcasting a notification that an event occurred to all the registered processes.

37. The apparatus as claimed in claim 33, the processor further receiving a response message from an external device.

38. The apparatus as claimed in claim 37, wherein the response message comprises of receiving one or more electronic envelopes from an external device, wherein the envelope comprises the process (ID); and the processor further distributing the received envelope to a process associated with the process (ID).

39. A machine-readable medium comprising instructions which, when executed by a machine, cause the machine to perform operations including:
determining if an event occurred;
generating a first electronic envelope by a first process, wherein the envelope comprises an process identification (ID); and
attaching the first electronic envelope to a request message, wherein the request message is generated by a transmit process.

40. The machine-readable medium as claimed in claim 39, further comprising instructions to cause selecting the transmit process prior to generating the request message.

41. The machine-readable medium as claimed in claim 39, further comprising instructions to cause registering one or more process designated as non-transmit process.

42. The machine-readable medium as claimed in claim 41, further comprising instructions to cause broadcasting a notification that an event occurred to all the registered processes.

43. The machine-readable medium as claimed in claim 39, further comprising instructions to cause receiving a response message from an external device.

44. The machine-readable medium as claimed in claim 43, wherein
the response message comprises one or more electronic envelopes from an external device, wherein the envelope comprises the process (ID); and
further comprising instructions to cause distributing the received envelope to process associated with the process (ID).

45. An apparatus operable in communication system, the apparatus comprising:
a processor, the processor configured to determine if an event occurred; the processor configured to generate a first electronic envelope by a first process, wherein the envelope comprises an process identification (ID); and the processor configured to attach the first electronic envelope to a request message, wherein the request message is generated by a transmit process.

46. The apparatus as claimed in claim 45, the processor further configured to select the transmit process prior to generating the request message.

47. The apparatus as claimed in claim 45, the processor further configured to register one or more process designated as non-transmit process.

48. The apparatus as claimed in claim 47, the processor further configured to broadcast a notification that an event occurred to all the registered processes.

49. The apparatus as claimed in claim 45, the processor further configured to receive a response message from an external device.

50. The apparatus as claimed in claim 49, wherein the response message comprises of receive one or more electronic envelopes from an external device, wherein the envelope comprises the process (ID); and the processor further configured to distribute the received envelope to a process associated with the process (ID).

51. A apparatus for configuring parameters in a communication system, the apparatus comprising:
means for receiving a request message, wherein the request message comprises an electronic envelopes having a process ID;
means processing the envelopes;
means for generating a response message; and
means for attaching a reply envelope to the response message, wherein the reply envelope comprises a target process ID.

52. The apparatus as claimed in claim 51, wherein the request message comprises a plurality of envelopes, each envelope comprising a process ID.

53. The apparatus as claimed in claim 51, wherein the reply envelope comprises a plurality of reply envelopes, each envelope comprising a target process ID.

54. A method of configuring parameters in a communication system, the method comprising:
receiving a request message, wherein the request message comprises an electronic envelopes having a process ID;
processing the envelopes;
generating a response message; and
attaching a reply envelope to the response message, wherein the reply envelope comprises a target process ID.

55. The method as claimed in claim 54, wherein receiving the request message comprises of receiving a plurality of envelopes, each envelope comprising a process ID.

56. The method as claimed in claim 54, wherein attaching the reply envelope comprises of attaching a plurality of reply envelopes, each envelope comprising a target process ID.

57. A apparatus for configuring parameters in a communication system, the apparatus comprising:
a processor, the processor receiving a request message, wherein the request message comprises an electronic envelopes having a process ID; the processor further processing the envelopes; the processor further generating a response message; and the processor attaching a reply envelope to the response message, wherein the reply envelope comprises a target process ID.

58. The apparatus as claimed in claim 57, wherein the request message comprises a plurality of envelopes, each envelope comprising a process ID.

59. The apparatus as claimed in claim 57, wherein the reply envelope comprises a plurality of reply envelopes, each envelope comprising a target process ID.

60. An apparatus operable in communication system, the apparatus comprising:
a processor configured to receive a request message, wherein the request message comprises an electronic envelopes having a process ID; the processor further configured to process the envelopes; the processor further configured to generate a response message; and the processor configured to attach a reply envelope to the response message, wherein the reply envelope comprises a target process ID.

61. The apparatus as claimed in claim 60, wherein the request message comprises a plurality of envelopes, each envelope comprising a process ID.

62. The apparatus as claimed in claim 60, wherein the reply envelope comprises a plurality of reply envelopes, each envelope comprising a target process ID.

63. A machine-readable medium comprising instructions which, when executed by a machine, cause the machine to perform operations including:
receiving a request message, wherein the request message comprises an electronic envelopes having a process ID;
processing the envelopes;
generating a response message; and
attaching a reply envelope to the response message, wherein each reply envelope comprises a target process ID.

64. The machine-readable medium as claimed in claim 63, wherein the request message comprises a plurality of envelopes, each envelope comprising a process ID.

65. The machine-readable medium as claimed in claim 63, wherein the reply envelope comprises a plurality of reply envelopes, each envelope comprising a target process ID.
